(19) United States
(12) Patent Application Publication
(10) Pub. No.: US 2026/0350231 A1
(43) Pub. Date: Nov. 5, 2026

(54) A METHOD FOR DETECTING FALSE OR SYNTHESIZED MEDIA

(71) Applicant: CTM Insights LLC, Yorktown Heights, NY (US)

(72) Inventor: Louis A. Steinberg, Yorktown Heights, NY (US)

(21) Appl. No.: 19/484,908

(22) PCT Filed: May 20, 2024
(86) PCT No.: PCT/US2024/030164

§ 371 Date: Nov. 17, 2025

Related U.S. Application Data
(60) Provisional application No. 63/468,076, filed on May 22, 2023.

(51) Int. Cl. G06F 21/64; H04L 9/00; H04L 9/08; H04L 9/30; H04L 9/32; H04N 21/835

(52) U.S. Cl. CPC G06F 21/64; H04L 9/0825; H04L 9/30; H04L 9/3247; H04L 9/50; H04N 21/835; H04L 2209/60

(57) ABSTRACT

A method and system for securing media content, that is comprised of at least one clip, from being one of synthetically generated and modified by demonstrating both the validity of the originator and integrity of the content includes determining at least one intent to be associated with the media associated with an originator, wherein the intent is one that will not be modified by at least one of truncating, compressing, transcoding, and other processing steps involved in at least one of the transmission and rendering of the media identifying, identifying the at least one intent within the media, signing the at least one identified intent with a private key associated with the originator to generate at least one signature associated with the at least one identified intent, and distributing the at least one signature.

### TECHNICAL FIELD

The present disclosure is generally related to media content in communication systems and, more particularly to detecting false or synthesized media content being distributed in communication systems.

### BACKGROUND

Any background information described herein is intended to introduce the reader to various aspects of art, which may be related to the present embodiments that are described below. This discussion is believed to be helpful in providing the reader with background information to facilitate a better understanding of the various aspects of the present disclosure.

Deepfakes, a broad category of manipulated or synthesized images, video, or audio that are meant to deceive, have grown in sophistication. Early examples in which photos were clumsily edited to change their meaning have given way to sophisticated, artificial intelligence (AI)-based manipulation through techniques such as Generative Adversarial Networks (GANs). More recently, the introduction of “synthetic” media (audio and visual) has allowed for the creation of deepfakes that may not be directly derived from a single source. By capturing pictures, video, and sound of a person, it's increasingly possible to create realistic versions of events that never happened. An image can be created of a politician accepting a bribe, an audio recording can be created of a person confessing to a crime, or a chief executive officer (CEO) can be shown presenting an earnings call, without any of them actually happening. When combined with interactive AI chatbots such as chatGPT, a synthetic deepfake can participate in a phone call or video conference without the consent of the person it claims to represent and can be made to say or do things which are different from the intentions of the person they are pretending to be. In one recent example, an employee at a bank in Hong Kong was tricked into disbursing large amounts of money when requested to do so by a group of corporate executives on a video conference call. Unfortunately, all of the participants except for the victim were synthesized deepfakes, and the funds were stolen.

Current detection and mitigation techniques center around three common approaches. The first approach is to look for “artifacts” that suggest the images or sound are falsely created or edited. As deepfake sophistication grows, this becomes increasingly difficult. The second approach is for systems that generate synthetic and edited images and audio to declare their origin. Unfortunately, those who wish to deceive are unlikely to declare that their deepfakes are false. A third approach is to “sign” content by inserting known content, such as watermarks and/or tripwires. Unfortunately, watermarks and tripwires can be easily copied into untrustworthy content.

A more recent approach is to cryptographically sign the content in a way that authenticates its creator (the “originator”). This approach may ensure the provenance and integrity of audio and video by leveraging cryptographic signatures to authenticate the origin. For example, a recent patent application, WO/2021/011333 (“METHODS FOR DETERMINING DATA INTEGRITY USING OVERLAPPING REGIONS”), uses a series of micro signatures to be able to efficiently isolate where portions of content have been modified.

However, this recent approach also presents several challenges. For example, it may be desirable to use a portion of content (a “clip”), such as audio, video or a portion of images shared on social media or in a news program. Signing an entire file to prove it is unmodified typically doesn't allow for a subset to be verified as, by definition, a subset of content is different from the original. Also, audio and video content is often compressed, colors adjusted, and resolution adjusted, all collectively referred to as transcoded, between the time that the content was created and the time that it is played back. Signal transmission networks seek to save bandwidth, storage systems seek to save space, and different playback devices have different limitations that affect their ability to process and render content. These changes can result in traditional cryptographic signatures of the content stream or file failing. Additionally, media content can be presented and delivered as it is created, making signing a complete file impossible, in addition to being pre-recorded and delivered at a later time. A phone call, a live presentation of an earnings call, and an interactive interview are all examples of live content that can be consumed in real time (in addition to being recorded for later delivery and playback). In these live settings, the use of interactive avatars that look and or sound like an individual, but which aren't authorized to represent the views of the individual they purport to be, can enhance the perception that they are legitimate.

Further, the authentication of an originator does not necessarily indicate that third party generated content, including content generated by AI claiming to act on behalf of an originator, is authorized to represent the originator's opinion. Authorization can be delegated, authentication cannot. This matters because deepfakes inherently intend to deceive; authorized avatars, similar to delegating authority to a person to represent you, do not have any deceptive intention. Given these challenges, it is clear that there is a need for a way to indicate that an image, audio, or video stream (or a subset thereof) is authorized to represent the views of the individual it claims to represent.

### SUMMARY

According to one implementation, a method for securing media content from being one of synthetically generated and modified by demonstrating both the validity of the originator and integrity of the content is described. The media content is typically comprised of at least one clip and the method includes determining at least one intent to be associated with the media associated with an originator, wherein the intent is one that will not be modified by one of truncating, compressing, transcoding, or other processing steps involved in the transmission or rendering of the media. The method further includes identifying the at least one intent within the media; signing the at least one identified intent with a private key associated with the originator to generate at least one signature associated with the at least one identified intent; and distributing the at least one signature.

According to one implementation, the at least one signature is distributed included alongside the media, in the media, or separate from the media. According to another implementation, the step of distributing the at least one signature utilizes one of an independent distribution channel, a network or a shared repository. According to a variation of the method the steps of determining, identifying, signing, and distributing are repeated on a plurality of the clips.

According to a further implementation, the media is comprised of one of an audio stream, a video stream, an image file, an audio file, a video file, or a text file. The media may contain an audio stream and the intent is at least one spoken word. The identified intent may be pre-processed before generating the signature. Further, the step of identifying the intent may be determined in a random manner or may be determined based on the value of the intent to the media. The value of the intent may be determined based on the linguistic strength of at least one word.

According to another implementation, a method for validating the originator and integrity of media content comprising at least one clip is described. The method includes receiving a clip that is identified as from the originator; selecting a type of intent that matches a type of intent used to secure the clip; processing the clip by identifying and extracting the intent associated with the clip; receiving and decrypting signatures associated with an intent using a public key associated with an originator; and scanning the decrypted intent and comparing an extracted intent with at least one decrypted intent to test for matches.

According to a variation of the implementation, the steps of selecting, processing, receiving signatures, decrypting and comparing are repeated on the plurality of intents within the clip. According to a further variation, the signatures are received along with the clip and the received signatures may be provided through an independent distribution channel or a shared repository. A notification to a recipient of the media content may be provided if the extracted intents does not match the decrypted intent. The notification may be one of an audio alert, a visual alert, or a tactile alert. The public key associated with the originator may be stored and retrieved from a public key repository. If the type of intent is audio and processing the subset of the media further includes processing the clip using a speech to text converter to generate data representing a set of words, the set of words representing the intent or intents.

According to another implementation, the extracted intents are tested to see if they are in the same order as the decrypted intents from the originator and optionally, only a predefined percentage of intents extracted from the at least one clip is required to match decrypted intents from the originator. The implementation may further include storing the received signatures or decrypted intents in a buffer, and if the extracted intent matches one of a received signature or a decrypted intent, then future scanning of the buffer begins at the location where the match was found.

According to another implementation, a system for securing media, comprised of at least one clip, from being one of synthetically generated and modified by demonstrating both the validity of the originator and integrity of the content is described. The system includes a first processor, associated with an originator. The processor is configured to determine the intent associated with the media to be secured associated with an originator, wherein the intent is one that will not be modified by one of truncating, compressing, transcoding, or other processing steps involved in the transmission of the media; identify the intent within the media; sign the intent with a private key associated with the originator to generate a signature associated with the identified intent; and distribute the at least one signature. The system further includes a second processor, associated with a recipient to validate the originator and integrity of media. The second processor is configured to receive a clip that is identified as from the originator; select a type of intent that matches a type of intent used to secure the clip; process the clip by identifying and extracting the intent associated with the clip; receive signatures associated with the intent; decrypt the received signature using a public key associated with an originator of the media's private key; and scan the decrypted intent and compare the extracted intent with the decrypted intent to test for matches.

### BRIEF DESCRIPTION OF THE DRAWINGS

The above and other aspects, features, and advantages of the present disclosure will become more apparent in light of the following detailed description when taken in conjunction with the accompanying drawings to which the principles of the present disclosure are applicable:

FIG. 1 is a block diagram of an exemplary media content validation system according to aspects of the present disclosure;

FIG. 2 is a diagram of an exemplary clip illustrating the origin intent processing operation according to aspects of the present disclosure;

FIG. 3 is an image illustrating the origin intent processing according to aspects of the present disclosure;

FIG. 4 is an image containing an exemplary clip which could be used to deceive a recipient of the image in FIG. 3 according to aspects of the present disclosure;

FIGS. 5A and 5B are diagrams of a further exemplary image 500 used for origin intent processing operation according to aspects of the present disclosure;

FIG. 6 is a block diagram of an exemplary processing device according to aspects of the present disclosure;

FIG. 7 is a flow chart illustrating an exemplary process for securing media content from being synthetically generated or modified according to aspects of the present disclosure; and

FIG. 8 is a flow chart illustrating an exemplary process for validating according to aspects of the present disclosure.

### DETAILED DESCRIPTION

It should be understood that the elements shown in the figures may be implemented in various forms of hardware, software or combinations on one or more appropriately programmed general-purpose devices, which may include a processor, memory and input/output interfaces. Those skilled in the art will be able to devise various arrangements which, although not explicitly described or shown herein, embody the principles of the disclosure and are included within its scope.

All examples recited herein are intended to aid the reader in understanding the principles of the disclosure and the concepts and are to be construed as being without limitation to such specifically recited examples and conditions. Any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor”, “module” or “controller” should not be construed to refer exclusively to hardware capable of executing software, and may implicitly include, without limitation, a System on a Chip (SoC), digital signal processor (“DSP”) hardware, read only memory (“ROM”) for storing software, random access memory (“RAM”), and nonvolatile storage.

The present disclosure addresses issues related to detecting or identifying false or synthesized media content. This false or synthesized media content is generally meant to deceive the recipient by misrepresenting either the media content of the originator, a party portrayed in the media content, or the intended meaning communicated by the media content itself. The issues have become ever more complex as advanced computing techniques, including AI and realistic computer-generated imagery, allow the creation of deepfakes that are nearly impossible to distinguish from real media content. Current approaches for addressing these issues have limitations, including the inability to check the authenticity of the originator and verify the integrity of the content (collectively, “validate”) when only a portion of the media content is present, the inability to validate transcoded media content, the inability to validate live content, and the inability to show authorization of the originator for the media content.

The present disclosure addresses these and other limitations by creating a new solution that combines the ability to validate clips of media content in cooperation along with assuring that the originator of the content or a party representing the originator has authorized the creation of the media content. The solution involves deriving an “intent”, or a meaning conveyed through such things as action, sound, relative position, or imagery, the wearing of specific items of clothing, or the background environment from the media content. The form of intent is media specific and typically attributed to an individual, sometimes referred to as an “originator”. An audible intent may be represented by individual words or sequences of words, or the volume, tone, and speed of language used. A visual intent may be represented by the presence of a specific object or the movements of a person or an object in the media content, for example, the swinging of a fist.

For example, vector graphics can be used to digitally represent movement across a set of video frames. Such vector graphics can be used to determine the relative motion of an object between multiple frames of a video, for example the movement of a car or dog in the video. In other embodiments, intent can be represented by the existence of or the size, color, shape, or coordinates (e.g., X-Y coordinates associated with the object) of one or more objects (for example, an image of a dog or car) in a still image or video frame. Those skilled in the art will quickly understand that these examples, while not exhaustive, were all selected so as to capture the intended meaning conveyed by media without necessarily relying on the specific media format to be precisely preserved (for example, video may be transcoded from motion picture entertainment group (MPEG) standard MP4 format to QuickTime movie .MOV format, audio may be transcoded from free lossless audio codec (FLAC) to MPEG standard MPEG audio layer III (MP3) or different codecs applied, and all may be compressed). These examples of intents, and others, can also be digitally captured from a subset of a clip (which itself is a subset of the full media). The use of the word subset is meant to also include the full set.

Intent is not expected to change if the clip is compressed, transcoded, or otherwise manipulated in ways typical for audio, video, and images. As a further example, lowering the resolution or changing the colors available to render in a video clip would not be expected to change the swinging of a fist, the words spoken, or the fact that an individual is located on a beach. Intents are periodically and/or continuously extracted from one or more clips of the media content. The form of intent does not change if the media is live, such as a phone call or video conference, or pre-recorded,

Once one or more intents are selected and extracted, they may be pre-processed to, for example, reduce space and/or preserve privacy, and validation information specific to the originator and intents is generated. This information may be a signature using an asymmetric encryption such as a public key infrastructure (PKI) to both detect tampering of the intent(s) as well as confirm their originator when tested with a public key. In one embodiment, groups of spoken words are converted to text and the text hashed before being signed. In another embodiment, “vector graphics” indicating motion in a portion of a video are signed. The signature of each intent (“signature”) may be transmitted with the media, through methods including but not limited to inserting artifacts like quick response (QR) codes, inserting into closed captioning, inserting into media metadata, or using steganography. The signatures may also be published to a publicly accessible or private repository such as a shared file, drive, bucket, or blockchain. Finally, they can be transmitted out of band by the originator to another party (e.g., a recipient of the media content), through mechanisms such as text messaging.

When a recipient has the media content and the validation information, such as signatures, for reproduction and/or consumption, the recipient can similarly extract intent(s) from one or more clips, optionally preprocess each intent in a manner compatible with that performed by the claimed originator, and use the PKI public key of the one or more claimed originators to decrypt associated signatures and verify that the intent(s) of the clip are both signed by a claimed originator and that the intent(s) haven't changed.

In some embodiments, the received intents and potentially other validation information will be stored in a buffer or file. Extracted intents from the clip can then be used to scan the buffer to find one or more matches. Once an extracted intent matches a received intent, or a set of extracted intents match a set of received intents, a pointer or other mechanism such as truncation can be used to avoid future re-scanning of received intents prior to the match. By shifting the starting point of scanning in the future, efficiencies are gained. By looking for more than one intent to potentially match within a window, errors based on a single, random matching of a received intent and an extracted intent, are reduced or eliminated. This “sliding window” technique can further be used to match a percentage of intents within a window, preferably in order, as described below.

It is worth noting that the validation process described above may also be used for verification as to whether media content is signed by the person, as the originator, they claim to be or represent.

In some embodiments, after the intents extracted from the clip are compared to the received intents, an audible, visual, or tactile indicator may be provided to the recipient as to whether the clip currently being consumed or processed is validated or not. For example, a colored dot or other visual indicator can be provided. Additionally, or alternatively, an audio alert or announcement can be provided to indicate to the recipient whether the clip was validated. Finally, a vibration or other tactile indication can be similarly provided.

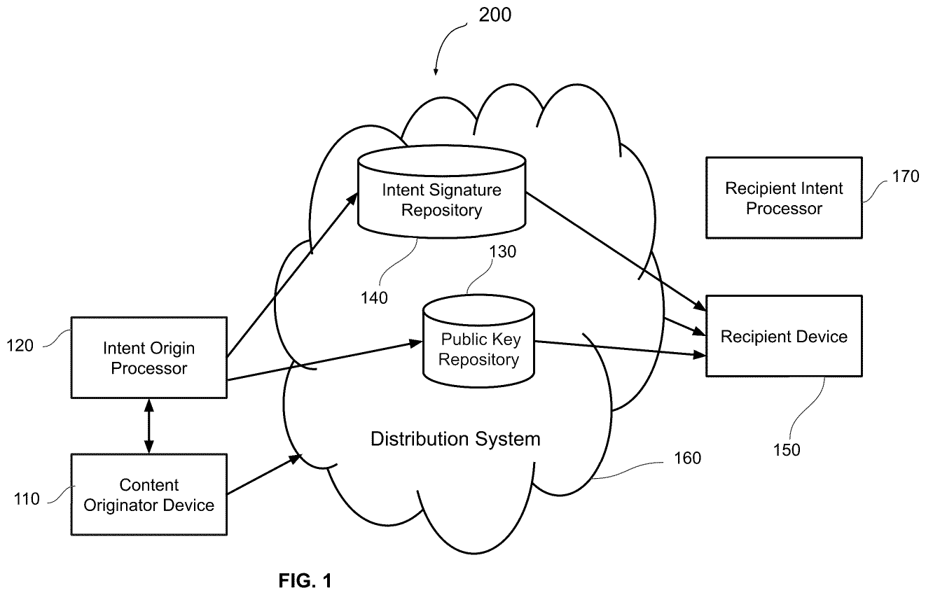

In a specific application, multiple participants are included on a video or audio conference call, or on a recording of a group presentation, with some or all of the participants who can act as originators. With multiple originators, the recipient device may need to receive and/or store sets of signatures associated with intents identified in the clips generated by each originator for each recipient, and each originator's intents may be processed and compared as described above. In some embodiments, each originator may pre-register their public key in a repository (e.g., public key repository 130 in FIG. 1) or as part of a web service or portal. The public key may be associated with the originator's identity (e.g., email, name, or username) for recipients to fetch when participating in an interactive conference or replaying a pre-recorded media content clip.

In some embodiments, it may be desirable for a synthesized version of a real person to be authorized by an originator. The originator's private key can be used to encrypt intents demonstrating that the clips were authorized by the originator. In some embodiments, the validation processing may be used by a recipient to determine whether a remote person on a live telephone call or videoconference is the person they claim to be or represent. In some embodiments, the validation processing may be included in an application that operates on a mobile or portable device used by an originator. A companion application may be used by a recipient on another mobile or portable device.

In some embodiments, special device drivers such as for a microphone, speaker, and video display, may be used to split audio and/or video streams for processing. In some embodiments special device drivers will be used to combine the signed intents back into an audio/video stream (for example, to embed QR and capture codes that contain the signed intents in a video stream, or to use closed caption, or to use steganography to embed and capture intents in audio or video.

FIG. 1 illustrates a block diagram of an exemplary media content delivery system 100 according to aspects of the present disclosure. In media content delivery system 100, content, in the form of audio, video, or data is generated by a content origination source, referred to as a content originator, at a content originator device 110. Content originator device 110 is coupled to origin intent processor 120. Origin intent processor 120 is coupled to both an intent signature repository 140 and a public key repository 130. Content originator device 110 is further coupled to recipient device 150, intent signature repository 140 and public key repository 130 are also coupled to recipient device 150. Content originator device 110 provides media content, processed as described below, to distribution system 160 and recipient device 150 requests and/or receives the media content from the distribution system 160 provided by content originator device but may receive media content that has been modified with an intent to deceive. It is worth noting that although only one of each element is shown in FIG. 1, in some embodiments, more than one of any or all of the elements may be present in media content delivery system 100 and coupled in a manner as shown. In particular, more than one content originator device 110 and more than one recipient device 150 may be present in media content delivery system 100. Further, one or more of the elements shown in FIG. 1 may be coupled using physical media or a network in distribution system 160. For example, content originator device 110 may be coupled to origin intent processor 120 as well as recipient device 150 through a network.

It is worth noting that distribution system 160 may encompass one or more different types of networks used at part of media content delivery system 100. For example, distribution system 160 may include a communication network allowing elements in media content delivery system to deliver and receive media content and related information through broadcast, managed or unmanaged wired or wireless communication network components. As another example, distribution system 160 may include physical media content distribution allowing transfer of media content on physical media, such as optical disks, memory drives, through physical structures such as warehouses, storefronts, and package delivery companies. As another example, distribution system 160 may encompass personal delivery allowing an originator to personally provide media content or other information to a recipient using physical media or a secure personal communication means.

Media content that is generated by a content originator may include live or pre-recorded audio, video, images, and/or data (e.g., textual) content. Some or all of the media content may be generated at different locations from the location of the content originator and may further be provided to the content originator from another content originator. The content originator may be a single individual person or may be a facility having multiple individuals. Examples of facilities include, but are not limited to, a content production studio, a media streaming studio, content distribution facility, a broadcast content distribution studio, and the like. The content originator device 110 is the device used to provide media content generated by the content originator to the recipient device (e.g., over a communication network). In some embodiments. Examples of content originator device 110 include, but are not limited to, a computer, a tablet, a cellular phone, a content production workstation, and the like.

Origin intent processor 120 is used to process the media content from the content originator in order to generate origin validation information, such as intents and signatures, for subsets of the media content. In some embodiments, the origin intent processor 120 may receive the media content from the content originator device 110, generate the origin validation information, and provide the origin validation information back to the content originator device 110. In some embodiments, the origin intent processor 120 may receive the media content from the content originator device 110, generate the origin validation information, and provide some or all of the validation information to the content originator device 110 and some or all of the origin validation information to the intent signature repository 140. For example, the origin intent processor 120 may provide a set of signed intents to the content originator device to be delivered with the media content to recipient device 150 and/or provide a set of signed intents to the intent signature repository 130. Further, the origin intent processor 120 may provide a public key associated with the content originator to the public key repository 130. In some embodiments, the content originator device 110 and the two repositories 130 and 140 may access the origin intent processor 120 over a communication network using an application interface or a uniform resource locator (URL). The origin intent processor 120 may also access the intent signature repository 140 and public key repository 130 over a communication network.

It is worth noting that in some embodiments, some or all of the functions of origin intent processor 120 may be included in content originator device 110. In embodiments where all of the functions of origin intent processor 120 are included in content originator device 110, origin intent processor 120 may not be present in media content delivery system 100.

Intent signature repository 140 provides storage for the origin validation information that is produced by the origin intent processor 120. In this manner, any time the media content from content originator is delivered to a recipient device 150, the origin validation information for that media content may also be accessed and/or provided, currently or in the future. In some embodiments, the intent signature repository 130 and/or the public key repository 130 may be connected to the origin intent processor 120 and/or the recipient device over a network connection, and storage elements of the intent signature repository 140 and/or the public key repository 130 may be distributed across the network. Such a configuration may be referred to as cloud storage and the intent signature repository 140 and/or the public key repository 130 may be a part of a cloud storage facility operation. Examples of storage that may be used may include, but are not limited to, hard disk drive arrays, solid state storage arrays, optical disk drive storage arrays, and the like.

Public key repository 130 provides storage for the public key that is associated with the originator of the media content or a delegated originator with the originator's authorization such as an authorized person or AI generator. The public key may be made available to a recipient and used in conjunction with processing the origin validation information associated with the media content generated by the originator. In this manner, any time the media content from content originator is delivered to a recipient device 150, the origin validation information for that media content may also be accessed and/or provided, currently or in the future. The public key repository 130 may be configured and operated in a manner similar to that described above for intent signature repository 140.

Recipient device 150 is operated by a recipient of media content provided through a network or on physical media. The content originator device 110 delivers the media content to the recipient device 150 either directly, through physical media, or over a network as shown by distribution system 160. In some embodiments, the content originator device 110 may also provide some or all origin validation information generated in the origin intent processor 120 to the recipient device. In some embodiments, the recipient device 150 may alternatively or additionally establish a communication connection with one or both of the intent signature repository 140 and the public key repository 130 in order to request and/or access the origin validation information. Examples of recipient device 150 include, but are not limited to, a desktop computer, a laptop computer, a tablet computer, a television, a radio, a cellular phone, and the like.

In operation, content originator device 110 provides the media content to origin intent processor 120. Origin intent processor 120 selects and extracts a set of intents, as described above. In some embodiments, a set of intents may be further processed to reduce the amount of data used or to create additional privacy. For example, the values representing each of the intents may be processed through a hashing algorithm. The origin intent processor 120 further encrypts each of the data values (either original or processed) using asymmetrical encryption. In some embodiments, the asymmetrical encryption may be public key infrastructure (PKI) encryption. In these embodiments, a public key associated with the originator may be provided through the origin intent processor 120 to the public key repository 130. In other embodiments, a different symmetric or asymmetric encryption may be used.

In some embodiments, the signatures for the set of intents, and other origin validation information, may be provided along with the media content to the content originator device. In other embodiments, the signatures for the set of intents may be inserted into the media content and the media content provided back to the content originator device 110. In still other embodiments, the signatures for the set of intents may be provided to intent signature repository 140. The content originator device 110 delivers the media content, with or without the origin validation information, including signatures, for the set of intents, to the distribution system 160. It is worth noting that, in some embodiments, the origin validation information in the intent signature repository 140 may include information about the types and extraction locations of the intents within the media content as well as any information associated with additional processing (e.g., hash algorithm).

When a recipient wishes to access media content, the recipient receives the media content through the distribution system 160 from recipient device 150. Distribution system 160 may provide the original media content delivered from content originator device 110 by the true originator of the media content as well as media content from other content providers that has been modified from the original media content and claiming to be the content originator. In some embodiments, the selected media content may be delivered along with origin validation information associated with the media content, either within the media content or separate from the media content. In other embodiments, the recipient device 150 accesses the set of signed intents for the selected media content from the intent signature repository 140. In still other embodiments, a separate communication link may be established between the originator and the recipient in order to transmit the set of intents through some mechanism outside of distribution system 160. The recipient device 150 processes the selected media content in a manner similar to that described above, selecting and extracting a set of intents through the recipient intent processor 170. In some embodiments, the processing includes performing a hash algorithm on the extracted intents. The recipient device 150 also receives additional origin validation information to recover the intents for the media content from the originator. In some embodiments, the recipient device 150 may also decrypt a set of signatures included in the origin validation information, the signatures associated with the intents for media content from the originator, in one of the ways described to recover the original set of intents used above. The decryption may be performed using a public key associated with the true content originator for media content. The public key may be retrieved from the public key repository 130. The recipient device 150 compares the intents recovered from the origin validation information to the set of intents extracted from the selected received media content, preferably in order, to validate or invalidate the selected clip is authentic, has maintained integrity and has been authorized by the content originator. Details about the origin validation process will be described in further detail below.

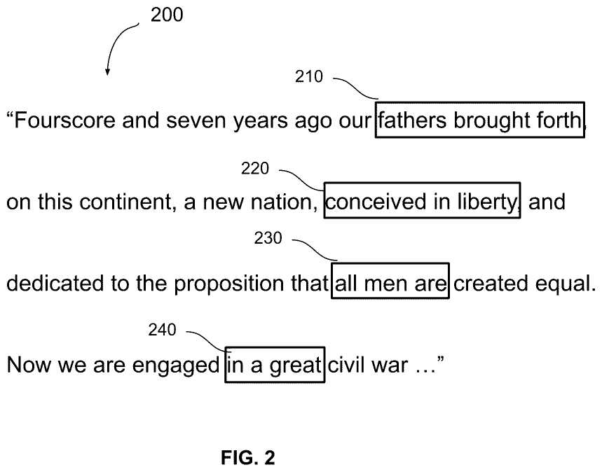

FIG. 2 is a diagram of an exemplary clip 200 illustrating the origin processing operation according to aspects of the present disclosure. The clip 200 may have been processed in an originator processing device (e.g., content originator device 110 and/or origin intent processor 120 described in FIG. 1). The origin processing used on clips includes identifying and extracting a set of intents and encrypting, also referred to as signing, the set of intents using, for example, an asymmetrical encryption, as described above. The encrypted intents may be referred to as signatures. The clip 200, along with the origin validation information generated as a result of the processing, may be provided for delivery to a recipient device (e.g., recipient device 150). The recipient device 150 receives the clip 200 and uses the origin validation information to validate the delivered clip.

The media content from which clip 200 has been taken may be part of a live audio and/or visual presentation produced by an originator to a recipient or may have been previously recorded and made available for later reproduction. The clip 200 represents a portion of spoken audio included as part of the media content. The spoken audio has been converted into text as part of the origin validation processing by the originator. It is worth noting that the recipient will also perform a similar spoken audio to text conversion when clip 200 is received. As part of the processing, a set of intents within the text are selected and identified as intent elements 210-240. By selecting a set of intents, or portions of the complete text, rather than all of the words, the amount of processing needed to produce signatures is significantly reduced. As shown, the intents are selected based on a specific pattern as every seventh to ninth word in the text. A pattern other than the pattern shown may also be used. For example, the pattern may vary the number of words, choosing groups of N words in different relative positions, where N is variable. In some embodiments, the specific pattern may be known to both the originator and recipient. In some embodiments, the specific pattern for the intents may be included along with the origin validation information. In some embodiments, the intents may be randomly selected so as to further complicate the ability to create fake media content by making it more difficult to determine which intents need to be preserved and then change media around them to reuse legitimate signatures. In some embodiments, the intents may be selected based on their linguistic or similar importance in the media content.

The selected intent elements 210-240 are encrypted, or signed, using an encryption algorithm. In some embodiments, a PKI encryption algorithm may be used. In some embodiments, a well-known protocol and system such as FiDO2, or similar or derivative systems such as “Passkey” can be used to sign the intents with a private key and simplify key registration, distribution, and management. The relationship between the intent element, the content of the intent, and the signature for the intent element is shown in Table 1:

TABLE 1

| Element | Intent (words) | Signature |
|---|---|---|
| 210 | fathers brought forth | 0x9352 |
| 220 | conceived in liberty | 0xE671 |
| 230 | all men are | 0x4A2B |
| 240 | in a great | 0x5C12 |

In some embodiments, intent elements 210-240 may be processed prior to encryption, or signing, by a hashing algorithm. For example, a one-way hashing algorithm may be used to reduce the size, or amount of data used, for intent elements 210-240. The one hashing algorithm may also be used to obscure the actual value intent elements 210-240 for reasons such as privacy. Other hashing algorithms may also be used.

The signatures for intent elements 210-240 may be stored in a repository (e.g., intent signature repository 140), provided along with the clip 200, or inserted into clip 200 as described above. In some embodiments, the signatures for intent elements 210-240 may be stored in the intent signature repository 140 or, alternatively, provided in order as part of the delivery of clip 200. By arranging the signatures in this manner, a recipient receiving media content clip 200 can verify that the same set of intent elements 210-240 are present in a specific order, for the clip 200 to be considered trustworthy.

The process of signing through encryption, such as PKI, minimizes the ability of synthetic media to be created without the consent (and access to the private key) of an originator who it purports to represent. By signing one or more intents instead of signing a specific technical instantiation of media content, the signatures are unaffected by typical media compressions, transcoding and streaming. By periodically signing intents within media content s, as described in FIG. 2, a subset or subsets of the media can be validated without having to present the full media. Should an originator desire to authorize the synthetic creation of their voice or likeness, they can do so by signing the resulting intents. Finally, this approach allows media to be live and interactive, or replayed after creation, without sacrificing any of the benefits.

By periodically signing media content in clips as described here, clips of the content can be viewed or heard by a recipient and verified. For example, a clip of a video can be posted on social media as news, and a recipient can validate that it was both signed by an originator who claims to be shown in the video and that the intent(s) haven't changed. If the type of intent chosen by the originator was words spoken, a speech to text engine could extract a subset of words that would then be signed and which must be present, preferably in order, in the clip.

As previously described, a receiver extracts intents from a clip and pre-processes them in a manner consistent with the originator, for comparison with signed intents from an originator. It is understood that when a receiver generates intents from clip to compare with the signed intents from an originator, errors may sometimes be introduced that makes the comparison fail. For example, the originator's text to speech engine might correctly identify the words “conceived in liberty” from FIG. 2, but the receiver's text to speech engine might generate the words “concealed in liberty”. When the words are hashed with the same hashing algorithm, they would generate different values. Therefore, in some embodiments, it may be desirable for a receiver to look at the values from a set of intents over a window of time or set (or subset) of received signatures. If the receiver decided that a subset (e.g., 4 out of the last 7) of intent values must match intent values signed by the originator, preferably in order, a degree of “error immunity” could be introduced into the system.

In one preferred embodiment, received signatures are stored in a buffer, whether continuously in a stream or fetched from the signature repository 140 associated with the media. The signatures are decrypted in the buffer using the public key known to belong to the speaker. As a clip is received or processed, a speech to text engine collects groups of words from the audio stream and hashes them. The buffer is then scanned for a matching hash, to see if that group of words was spoken by that person in the given clip. A match validates the words spoken.

In some embodiments, the intents extracted from the clip may be checked against the intents in the above buffer to ensure that they not only match but are also present in the same sequence. Once an intent is successfully matched by scanning, the intents stored prior to that point in the buffer may be skipped in future validations. As an example, using spoken words similar to that used in FIG. 2, as a clip is processed, intents are created based on groups of words. In some cases, a hashing algorithm can be used that advances one word at a time and generates overlapping hashes. The first set of 3 received words are compared to the decrypted intents in memory with a scan starting with the first decrypted intent or the last match found. When a match is found any future scans can start from that point in the buffer. This approach both increases scan performance and increases the accuracy of validation by forcing intents, such as groups of words, to be in the correct order.

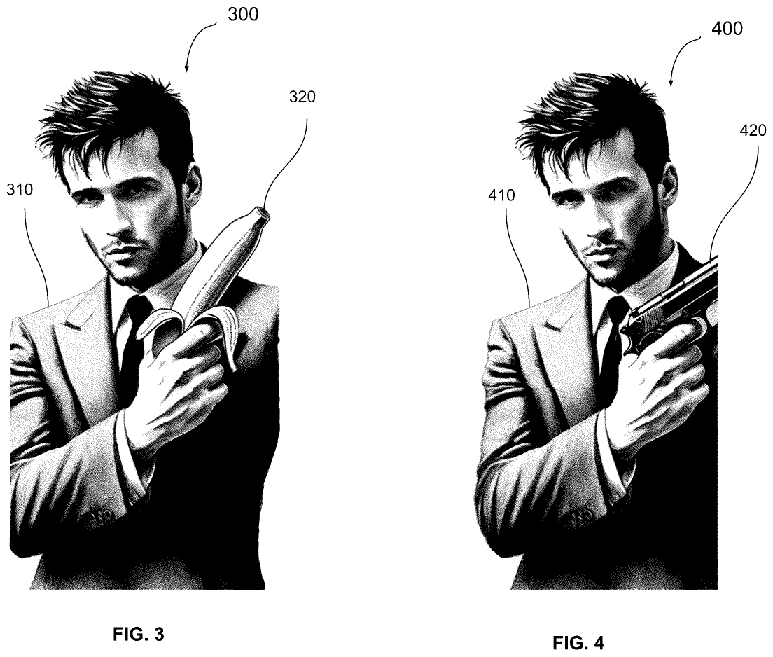

FIG. 3 shows a diagram of another exemplary image 300, representing a still image, the origin processing operation according to aspects of the present disclosure. The image 300 may be processed in an origin processing device (e.g., content originator device 110 and or origin intent processor 120 described in FIG. 1) as described above. The image 300, along with the origin validation information generated as a result of the processing, may be provided for delivery to a recipient device (e.g., recipient device 150) where it is processed in a manner similar to that described above.

The media content from which image 300 has been taken may be a photograph, a cartoon, or a still image as part of a live audio and/or visual presentation produced by an originator and made available to a recipient. Alternatively, the media content may have been previously produced and/or recorded and made available for later reproduction and/or distribution. The image 300 includes element 310, a partial image of a human male in a suit, and element 320, a peeled banana being held in the right hand of element 310, the human male. As part of the processing, some or all of element 320 may be identified and selected as an intent element. In other words, the intent of the originator of the image 300 is for element 310, a human male, to hold element 320, a peeled banana, in the position as shown. In some embodiments, additional intents may be selected within element 310. The intents may be selected based on a specific pattern, selected based on importance in media content clip 300, or selected randomly as described above. In some embodiments, the specific pattern may be known to both the originator and recipient. In some embodiments, the specific pattern and/or locations for the intents may be included along with the origin validation information.

The selected intent 320 is signed using an encryption algorithm, such as the PKI algorithm described above. In some embodiments, intent 320 may also be processed prior to encryption, or signing, using a hashing algorithm as described above. The signature(s) for intent 320 may be stored in a repository (e.g., intent signature repository 130), provided along with the image 300, or inserted into the media content clip as described above. The signatures may be stored in a repository or, alternatively, provided in order as part of the delivery of image 300.

FIG. 4 shows a diagram of an exemplary image, representing a clip of a still picture, having an intent to deceive a recipient of image in FIG. 3 and illustrating a change in intent according to aspects of the present disclosure. Image 400 is similar to image 300 described. However, image 400 has been manipulated with the intent to deceive a recipient by altering the intent within image 300. Image 400 includes element 410, a partial image of a human male in a suit, the same as in FIG. 3. However, media content 400 includes element 420, a hand pistol being held in the right hand of element 410, the human male, and not the peeled banana, element 320, as in FIG. 3.

The image 400, including the altered visual content, is provided to a recipient device (e.g., recipient device 150) and identified as the same media content as image 300. In some embodiments, image 400 may have been selected by the recipient without the knowledge that image 400 was created with the intent to deceive. Image 400 is processed using the origin validation information associated with image 300 in a manner similar to that described above. The recipient intent processor 170 identifies and extracts the intents from image 400 based on intents selected in FIG. 3 and provides the intents to the recipient device 150. The recipient device further decrypts the signatures received as part of the origin validation information for the selected intents in the image (e.g., intent 320 in FIG. 3) in a manner similar to that described above. The recipient device compares the extracted intent 420 to the decrypted intent from the origin validation information. The comparison indicates that the data associated with intent 420, a hand pistol, is not the same as the data associated with the intent 320 from image 300 a peeled banana. As a result, the comparison fails and the image 400 has not been verified.

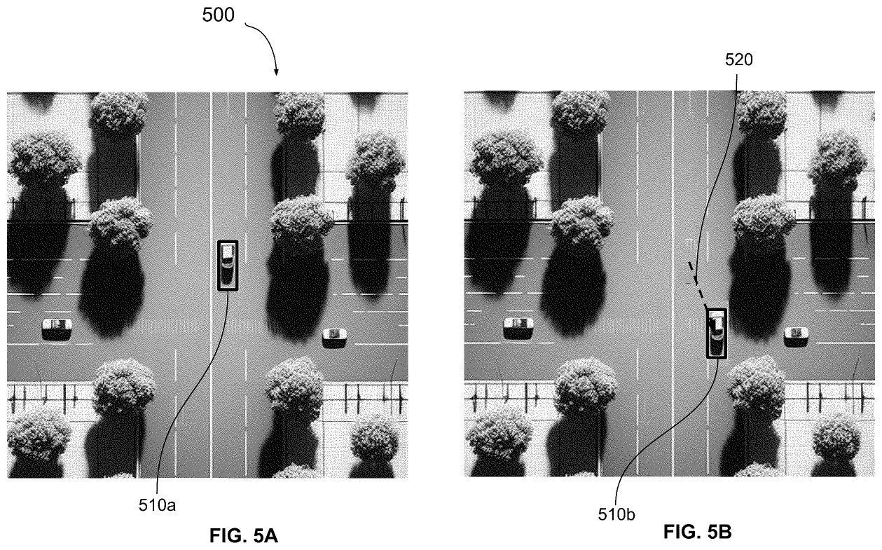

FIGS. 5A and 5B show diagrams of a further exemplary clip 500 illustrating the origin processing operation according to aspects of the present disclosure. The clip 500 may be processed in an originator processing device (e.g., content originator device 110 and/or origin intent processor 120 described in FIG. 1) as described above. The clip 500, along with the origin validation information generated as a result of the processing, may be provided for delivery to a recipient device (e.g., recipient device 150) where it is processed in a manner similar to that described above.

Clip 500 includes two frames of video content. The video may be a series of still video images taken at time intervals or may be a motion picture or streaming video as part of a live audio and/or visual presentation produced by an originator and made available to a recipient. Alternatively, the video may have been previously produced and/or recorded and made available for later reproduction and/or distribution. The clip 500 includes element 510a in FIG. 5A, an image of a vehicle at a first location or position along a roadway intersection at a first instant of time. The media content clip 500 further includes element 510b, an image of the same vehicle at a second location or position along the roadway intersection at a second, subsequent instant of time. The difference in the location of element 510a in FIG. 5A and the location of element 510b is selected as an intent from clip 500. Data representing the location of element 510a in FIG. 5A and the location of element 510b in FIG. 5B is identified and extracted and used to determine the value for the selected intent 520. The value may be determined using a difference in relative position along the roadway using x-y coordinates or vector coordinates. The value may also be determined using other computational methods, such as speed, acceleration, and the like. It is worth noting that, in some embodiments, additional intents may be identified used along with intent 520, including intents associated with elements in clip 500 that remain stationary between FIG. 5A and FIG. 5B, in a manner similar to that described above.

The selected intent 520 is signed using an encryption algorithm, such as the PKI algorithm described above. In some embodiments, intent 520 may also be processed prior to encryption, or signing, using a hashing algorithm as described above. The signature for intent 520 may be stored in a repository (e.g., intent signature repository 140), provided along with the clip 500, or inserted into the clip as described above.

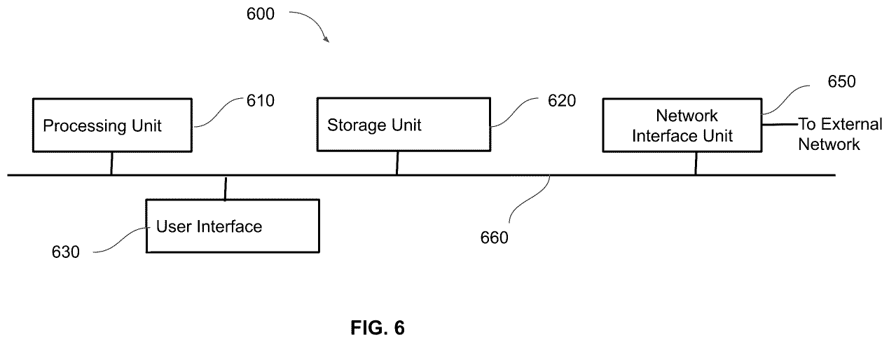

FIG. 6 is a block diagram illustrating an example of a processing device 600 according to aspects of the present disclosure. Processing device 600 may operate as part of a communication system, such as media content delivery system 100 described in FIG. 1. More particularly, processing device 600 may be configured to operate as a device for generating origin validation information associated with media content, such as origin intent processor 120. The processing device 600 includes a processing unit 610, a storage unit 620, user interface 630, and a network interface unit 650 which are connected together electrically or otherwise coupled together by a bus 660. Of course, constituent elements of the processing device 600 may be coupled together by a mechanism other than a bus connection using the bus 660. It is worth noting that several components and interconnections necessary for complete operation of processing device 600 are not shown in the interest of conciseness, as the components not shown are well known to those skilled in the art.

The processing unit 610 controls operations of the processing device 600. Processing unit 610 further performs any processing on media content or other information associated with the media content received through network interface unit 650 based on instructions provided either from another device (e.g., content originator device 110 in FIG. 1) or instructions received through user interface 630. The processing performed by processing unit 610 may include, but is not limited to, identification, selection, and extraction of portions of media content, hashing portions of or elements of media content, and encryption or decryption of portions of media content. The processing unit 610 also provides the processed media content as well as any processed portions of media content to other devices (e.g., content originator device 110, public key repository 130, and intent signature repository 140 in FIG. 1).

The storage unit 620 stores at least one program to be executed by the processing unit 610, and various data, including media content, subsets of media content, intents extracted from media content, and any other information associated with the media content that is used as part of the processing in in the processing unit 610. The storage unit 620 is formed by any suitable storage or means capable of storing the program, data, or the like in a computer-readable manner. The user interface 630 may include one or more input elements that may be used by a user for entering data and/or control operation of processing device 600. The network interface unit 650 provides an interface between the processing device 600 and any external devices, such as a content originator device 110, repositories 130 and 140 in FIG. 1.

In operation, media content is received from a content originator device 110 in FIG. 1) and provided to the processing unit 610. The intents may be identified and selected in a manner similar to that described above. In some embodiments, the instructions may include encrypting the intents to generate signatures associated with intents using an asymmetrical encryption as described above. In some embodiments, the instructions may include processing the intents using a hashing algorithm, as described above, prior to encrypting. The origin validation information may be provided through network interface unit 650 to the content originator device or alternatively provided to a repository (e.g., intent signature repository 140) based on instructions.

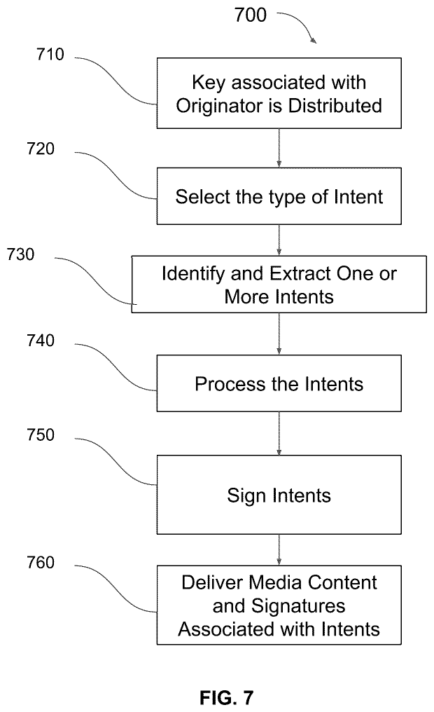

FIG. 7 is a flow chart illustrating an exemplary process 700 for generating media that is secure from being synthetically generated or modified according to aspects of the present disclosure. Process 700 is primarily described with respect to a media content device that is configured to operate as an originator. One or more elements of process 700 may also be performed by elements in a media distribution system used to generate, distribute, and receive media content, such as media content delivery system 100 described in FIG. 1, such as content originator device 110 and/or origin intent processor 120. Although process 700 depicts steps performed in a particular order for purposes of illustration and discussion, the operations discussed herein are not limited to any particular order or arrangement. One skilled in the art, using the disclosure provided herein, will also appreciate that one or more of the steps of process 700 may be omitted, rearranged, combined, and/or adapted in various ways.

At step 710 a key associated with the originator is distributed to the recipient, such as using distribution system 160 in FIG. 1 to send it to the recipient device 150 or the recipient intent processor 170. Additionally, or alternatively, it may be sent to public key repository 130. The key may be a public key if asymmetric encryption algorithms, such as PKI are used, or it may be a private key if symmetric encryption is used.

At step 720, a type of intent is selected for media content generated or produced by an originator. The media may be generated and/or produced using audio and visual elements of a user interface. The intents may be values for words that are spoken, values associated with some or all of an object, or values associated with movement of objects. The intents may be selected based on the type of media, (e.g., audio, still image, video) that is included in the media content as described above in FIGS. 2, 3 and 5.

At step 730, one or more intents are identified such as by origin intent processor 120 in FIG. 1. The intents that are identified are of the type of intent selected at step 710 based on the type of media in the media content. Further, the intents may be identified, at least in part, based on a pattern, or may be identified and selected randomly. The location of the intents within the media, or other identifying information, may also be extracted.

At step 740, the one or more intents, identified and extracted at step 730, are processed, again, such as by origin intent processor 120. The processing may include hashing the data values to reduce the amount of data used for the intents. For example, the intents may be hashed using a one way hashing algorithm.

At step 750, the one or more intents, processed at step 740, are signed to generate a signature for each of the intents. The signatures may be generated using an encryption algorithm, such as PKI, as described above. The signatures may be stored along with any location or other identifying information.

At step 760, the media content from step 710, along with the signatures associated with the intents and generated at step 750, are delivered. The media content and signatures associated with the intents may be delivered using the distribution system 160 in FIG. 1. As an example, the media content and the signatures may be delivered as a media signal through a communication network to one or more recipient devices. The signatures may be provided to a repository, such as the intent signature repository 140, prior to being provided to the recipient devices. As another example, the signatures may be provided through a communication network to the repository while the media content may be provided through a physical media distribution network for inclusion on an optical disk and distributed to one or more recipient devices.

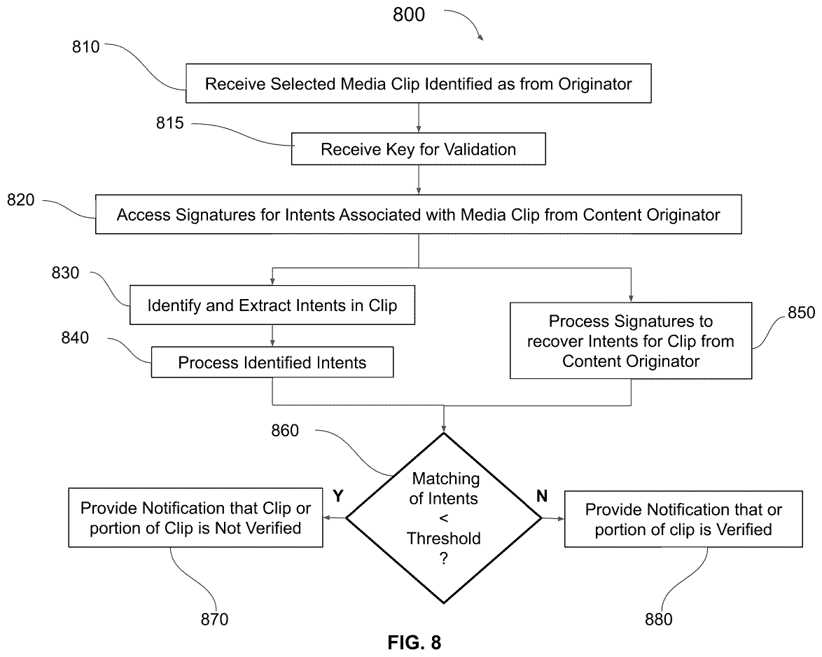

FIG. 8 is a flow chart illustrating an exemplary process 800 for validating media content according to aspects of the present disclosure. Process 800 is primarily described with respect to a media content device that is configured to operate as a recipient device such as media content device. One or more elements of process 800 may also be performed by elements in a media distribution system used to generate, distribute, and receive media content, such as recipient device 150 in media content delivery system 100 described in FIG. 1. Although process 800 depicts steps performed in a particular order for purposes of illustration and discussion, the operations discussed herein are not limited to any particular order or arrangement. One skilled in the art, using the disclosure provided herein, will also appreciate that one or more of the steps of process 800 may be omitted, rearranged, combined, and/or adapted in various ways.

At step 810, a clip is received (e.g., through distribution system 160 in FIG. 1). The clip is identified as being from the originator of the media that the user of the recipient device 150 has requested to view, listen to, or otherwise consume.

At step 815, a decryption key associated with the Originator is received, such as through distribution system 160. It may be received from public key repository 130 in FIG. 1, such as when PKI encryption is used, or may have been previously distributed through a secure mechanism such as when symmetric encryption is used.

At step 820 a set of one or more signatures associated with intents for the media content from the originator of the clip are accessed and received. The signatures may be received from the same distribution system or a different distribution system than the clip received, at step 810. For example, the clip may be provided on a USB flash drive as described above and the origin validation information may be provided from a repository (e.g., intent signature repository 140 in FIG. 1).

At step 830 one or more intents are identified and extracted from the clip, received at step 810. In some embodiments, the intents may be generated based on information, such as location and pattern information processed and recovered from the origin validation information. The identification and extraction of the intents from the received clip may be carried out by the recipient intent processor 170 in FIG. 1.

At step 840 the intents identified and extracted, at step 830, are processed. In some embodiments, the processing includes applying a hashing algorithm to the intents. For example, a one-way hashing algorithm matching the hashing algorithm that was applied to the intents from the clip generated by the content originator may be applied. The processing of the intents from the received clip may be carried out by the recipient intent processor 170.

At step 850, the set of signatures received, at step 820, are processed to generate one or more intents associated with the clip created by the content originator, as described above. The processing may include decrypting each of the signatures using a decryption algorithm to recover the intents. In some embodiments, the decryption algorithm may be a PKI algorithm. A public key associated with the content originator may be accessed and retrieved through the distribution system (e.g., distribution system 160 in FIG. 1). For example, the public key may be accessed and retrieved from a key repository (e.g., public key repository 130) and provided through a communication network.

It is worth noting that steps 830 and 840 may be performed simultaneously, or near simultaneously, with step 850 in process 800. In this manner, as the signatures are processed to recover intents for the clip from the content originator, at step 850, the intents are also identified, extracted, and processed, in steps 830 and 840. In some embodiments, the intents that are recovered, at step 850, may also be associated with origin content information that can be used as part of identifying and extracting the intents, at step 830.

At step 8060, a determination is made as to whether a number or percentage of the intents associated with the clip from the originator and recovered from the signatures received at step 820 match intents extracted from the clip received at step 810. The determination may be carried out by comparing the data value for an intent at a location in the received clip to the data value for that same intent recovered from the origin validation information, or by searching the data values of intents generated by the received clip to see if they match the data values of intents from the originator. In some embodiments, the determination uses a threshold of 100 percent, or all of the intents match. In other embodiments, the determination uses a threshold of less than 100 percent or less than all of the intents match in order to account for errors that may exist between the processing of the received clip and any processing of the clip by the content originator, as described above. Further, in some embodiments, the determination may include storing the intents generated for the clip from the content originator in a memory) and using a scanning mechanism or sliding window, as described above, to also ensure that the intents extracted from the received clip are in the correct order.

If, at step 860, it is determined that the number or percentage of intents that match is less than the threshold, then at step 870 a notification may be provided to indicate that the validation of the clip, or a subset of the clip, received at step 810, has failed. For example, an audible alert or message may be sounded through a speaker, or a color may change on the screen.

If, at step 860, it is determined that the number or percentage of intents that match is greater than or equal to (i.e, not less than) the threshold, then, at step 880 a notification different from the notification provided at step 870, is provided to indicate that the validation of the clip, or a subset of the clip, has succeeded. The notification to indicate that the received clip has been verified may also be provided in a manner similar to that described above.

It is worth noting that in some embodiments, a notification may only be provided if the number or percentage or number of intents that match is less than the threshold at step 860. In these embodiments, providing a notification at step 880 may be omitted from process 800.

It is to be appreciated that, except where explicitly indicated in the description above, the various features shown and described can be considered cumulative and interchangeable, that is, a feature shown in one embodiment may be incorporated into another embodiment.

Although embodiments which incorporate the teachings of the present disclosure have been shown and described in detail herein, those skilled in the art can readily devise many other varied embodiments that still incorporate these teachings. Having described preferred embodiments for a method for detecting false or synthesized media, it is noted that modifications and variations can be made by persons skilled in the art in light of the above teachings. It is therefore to be understood that changes may be made in the particular embodiments of the disclosure which are within the scope of the disclosure as outlined by the appended claims.

1. A method for securing media content, that is comprised of at least one clip, from being one of synthetically generated and modified by demonstrating both the validity of the originator and integrity of the content, the method comprising:
determining at least one intent that is associated with the media content from the originator, wherein the at least one intent is at least one of a spoken (i) single word and (ii) a plurality of words within a series of words that is selected by at least one of (x) the semantic importance of the at least one (i) single word and (ii) the plurality of selected words within a series of words and (y) a statistical sampling of words in the media content that has a probability that is greater than a predefined threshold of including semantically important words, such that the at least one intent will not be modified by at least one of truncating, compressing, transcoding, and other processing steps involved in at least one of the transmission and rendering of the media;
signing the at least one identified intent with a private key associated with the originator to generate at least one signature associated with the at least one identified intent; and
distributing the at least one signature.

2. The method of claim 1, wherein the at least one signature is distributed in at least one of (i) included alongside the media, (ii) in the media, and (iii) separate from the media.

3. The method of claim 2, wherein the step of distributing the at least one signature utilizes at least one of (i) an independent distribution channel, (ii) a network and (iii) a shared repository.

4. The method of claim 1, wherein the steps of determining, identifying, signing, and distributing are repeated on a plurality of the clips.

5. The method of claim 1, wherein the media is comprised of at least one of (i) an audio stream, (ii) a video stream, (iii) an image file, (iv) an audio file, (v) a video file, and (vi) a text file.

6. (canceled)

7. The method of claim 1 wherein the at least one identified intent is pre-processed before generating the at least one signature.

8. The method of claim 1 wherein the step of determining the at least one intent is based on a repeating pattern.

9. (canceled)

10. (canceled)

11. The method of claim 3 wherein the shared repository is a blockchain.

12. The method of claim 1, further comprising:
receiving a clip that is identified as from the originator;
selecting a type of intent, the type of intent matching a type of intent used to secure the at least one clip;
processing the clip by identifying and extracting at least one intent associated with the at least one clip;
receiving signatures associated with the at least one intent;
decrypting the at least one received signature using a public key associated with an originator of the media content; and
scanning the at least one decrypted intent and comparing the at least one extracted intent with the at least one decrypted intent to test for matches.

13. The method of claim 12, wherein the steps of selecting, processing, receiving signatures, decrypting and comparing are repeated on the plurality of intents within the clip.

14. The method of claim 12, wherein the signatures are received along with the clip.

15. The method of claim 12, wherein the received signatures are provided through at least one of (i) an independent distribution channel and (ii) a shared repository.

16. The method of claim 12, further comprising providing a notification to a recipient of the media content if at least one of the extracted intents does not match the at least one decrypted intent.

17. The method of claim 16 wherein the notification is at least one of (i) an audio alert, (ii) a visual alert, and (iii) a tactile alert.

18. The method of claim 12, wherein the public key associated with the originator of the media content may be stored and retrieved from a public key repository.

19. The method of claim 12, wherein the type of intent is audio and wherein processing the subset of the media further includes:
processing the clip using a speech to text converter to generate data representing a set of words, the set of words representing the intent or intents.

20. The method of claim 12 wherein the extracted intents are tested to see if they are in the same order as the decrypted intents from the originator

21. The method of claim 12 wherein only a predefined percentage of intents extracted from the at least one clip is required to match decrypted intents from the originator.

22. The method of claim 12 in which at least one of the (i) received signatures and (ii) decrypted intents are stored in a buffer, and if at least one extracted intent matches at least one of the (i) received signature and (ii) decrypted intent, then future scanning of the buffer begins at the location where the match was found.

23. (canceled)

24. A method for securing media content from being one of synthetically generated and modified by demonstrating both the validity of an originator and integrity of the content, the method comprising:
determining at least one intent related to at least one of a (i) video stream, (ii) video file and (iii) at least one still image, wherein the intent is an object selected based on at least one of its (a) semantic image importance and (b) semantic motion importance within the at least one of the (i) video stream, (ii) video file, and (iii) at least one still image such that the intents will not be modified by at least one of truncating, compressing, transcoding, and other processing steps involved in at least one of the transmission and rendering of the media;
signing the at least one identified intent with a private key associated with the originator to generate at least one signature associated with the at least one identified intent; and
distributing the at least one signature.

25. The method of claim 24 further comprising:
receiving a media content that is identified as from the originator;
selecting a type of intent, the type of intent matching a type of intent used to secure the media content;
processing the media content by identifying and extracting at least one intent associated with the media content;
receiving signatures associated with the at least one intent;
decrypting the at least one received signature using a public key associated with an originator of the media content; and
scanning the at least one decrypted intent and comparing the at least one extracted intent with the at least one decrypted intent to test for matches.
